(19) United States
(12) Patent Application Publication
(10) Pub. No.: US 2007/0020459 A1
(43) Pub. Date: Jan. 25, 2007

(54) Method and article for a dye sublimatable cast polymer

(76) Inventors: Kristian G. Roberts, Riverton, UT (US); Kyler G. Roberts, Salt Lake City, UT (US); Matthew G. Wilson, Sandy, UT (US)

Correspondence Address: THORPE NORTH & WESTERN, LLP., 8180 SOUTH 700 EAST, SUITE 200, SANDY, UT, 84070, US

(21) Appl. No.: 11/483,145

(22) Filed: Jul. 6, 2006

Related U.S. Application Data
(60) Provisional application No. 60/697,259, filed on Jul. 6, 2005.

(51) Int. Cl. B32B 27/00; B28B 7/38

(52) U.S. Cl. 428/411.1; 427/133; 264/255

(57) ABSTRACT

Dye sublimatable deformable cast polymer articles, and methods for producing these are provided. The presently claimed invention is drawn towards a method for producing a dye sublimatable cast polymer article being inherently resistant to UV and heat exposure. A dye sublimatable cast polymer article having a protective coating is further disclosed.

This application claims the benefit of U.S. Provisional Ser. No. 60/697,259, filed Jul. 6, 2005, and entitled, “Method and Article for a Dye Submilmatable Cast Polymer;” which is incorporated by reference in their entirety herein.

### FIELD OF THE INVENTION

The present invention relates to dye sublimatable cast polymers and methods for producing the same. More particularly, the present invention relates to cast polymers capable of receiving a sublimated dye, and also cast polymers having a protective coating having, at least, ultra-violet and heat resistant properties, which protective coating may be dye sublimatable or applied as an overcoat to a dye sublimated cast polymer.

### BACKGROUND OF THE INVENTION AND RELATED ART

In recent years there has been an increase in interest and demand for synthetic deformable cast polymers. Not withstanding the functionality, cast polymers created from decorative finishing materials have been sought after for aesthetic purposes. Among those decorative finishing materials that are the most popular include synthetic deformable cast polymer materials having a gloss or high-gloss coating, which include, but are not limited to, cultured marble, cultured onyx, and cultured granite. These materials are extremely popular for use on kitchen and bathroom surfaces, such as countertops, sinks, bathtubs, showers, etc. Other uses for such deformable cast polymer materials include interior finishing elements (e.g., ceiling and wall coverings, facings, doors, moldings, window trimmings); furniture products (e.g., tables, chairs, shelving, and coat racks); illuminating devices (e.g., lamps, lighting fixtures, etc.); hardware accessories (e.g., plate covers for light switches and electrical sockets, knobs, picture or mirror frames, etc.); kitchen items (e.g., utensils, plates, etc.); bathroom items (e.g., soap dishes and dispensers); visual display items (e.g., signage, artwork, sculptures, etc.); and various other items.

In addition, to the variety of applications, synthetic cast polymers provide a non-porous surface, durability, stain-resistibility, and allow the surface to be renewed. Overall, the properties of synthetic cast polymers reduce the amount of damage, wear and prevent stains and bacteria from embedding into the polymer due to the relatively non-porous and smooth surface. Furthermore, the renewable aspect of synthetic cast polymers allows users to renew the surface by the application of a resin or abrasive material.

Of these deformable cast polymer decorative finishing materials, cultured marble is probably the most popular amongst consumers due to its relatively inexpensive price, looks, and its ease of maintenance. The manufacturing of cultured marble is well known in the art. Generally, cultured marble comprises a polyester product having a translucent gel coat product sprayed onto a glass mold and allowed to dry. Once the coating is dry, a mixture of a marble dust and a polyester resin are poured into the mold and vibrated to allow the air bubbles to migrate away from the surface of the gel coat to the top or backside of the marble substrate. Typically these marble substrates have a color and a type of color pattern stirred into the second stage of this process to imitate marble veins. The cultured marble substrates are then allowed to cure until hard, at which time they undergo a finishing step, including stripping the substrate of any sharp edges, wherein the cultured marble substrate is ready for installation. Other deformable cast polymer decorative finishing materials are manufactured in a similar manner. For example, if cultured granite is desired, specially formulated chips will be blended together to make a salt and pepper looking cultured granite substrate. As such, the finished look of these decorative finishing materials may include solids or various patterns or designs.

With improvements in printing technology, it has been desirable to further finish a deformable cast polymer article by printing one or more images or patterns thereon. One of the more common printing techniques known in the art is referred to as heat transfer printing, which is the practice of printing onto various items, such as textiles or plastics, using dye sublimation. Dye-sublimation comprises an image or pattern printed onto an image transfer medium with a subliming dye or ink. Once an appropriate image is formed on the image transfer medium, the medium is pressed against the item on which the print is to be transferred and heated for a brief period of time, whereby the ink is vaporized and transferred to the item. The high temperatures and pressures allow the dye to penetrate into the surface of the item, thus forming the design image or pattern supported on the image transfer medium. Other sublimation printing techniques are also well known in the art that involve a similar technique.

Although traditional deformable synthetic cast polymers have provided aesthetic and functional qualities, the gel coating used in traditional synthetic cast polymers is not suitable for the high temperatures of dye sublimation. When exposed to the temperatures involved in dye sublimation traditional polyester gel coats inherently discolor and break down. In addition the dyes themselves are innately non-ultra violet stable and therefore require some type of protection from ultra violet (UV) light. Currently, the sublimated dyes lack sufficient lightfastness properties and begin to fade when exposed to UV light, thus traditional synthetic cast polymers which have been dye sublimated are limited to indoor uses. Furthermore, standard gel coating lacks the durability or the ability to allow deep penetration to pass industry standard scrub testing.

### SUMMARY OF THE INVENTION

In light of the problems and deficiencies inherent in the prior art, the present invention seeks to overcome these by providing a novel dye sublimatable cast polymer article and method for forming a dye sublimatable cast polymer article. The cast polymer article is configured to be dye sublimatable with or without a gel coat present. In addition, the cast polymer article comprises a protective coating having at least, properties resistant to ultra-violet (UV) radiation and heat. The protective coating itself may also be dye sublimatable, or used simply as a protective coating to be applied to an existing dye sublimated cast polymer article.

Therefore, it is an object of some of the exemplary embodiments of the present invention to provide a novel article and method for forming a dye sublimatable cast polymer having a coating configured to comprise UV and heat resistant properties.

It is another object of some of the exemplary embodiments of the present invention to provide a novel article and method for dye sublimating to a cast polymer article without a gel coat, wherein the cast polymer article comprises a protective coating having, at least in part, properties resistant to ultra-violet radiation and heat. The protective coating itself may or may not be dye sublimatable.

It is another object of some of the exemplary embodiments of the present invention to provide a method for creating a dye sublimatable cast polymer article having a protective coating or surface comprising UV and heat resistant properties.

It is still another object of some of the exemplary embodiments of the present invention to provide a cast polymer article with a protective coating which is able to be dye sublimated and does not discolor when exposed to high temperatures.

It is a further object of some of the exemplary embodiments of the present invention to provide a cast polymer article with a protective coating that improves the lightfastness of the sublimated dye when exposed to UV light.

It is yet another object of some of the exemplary embodiments of the present invention to provide a method for treating the finished surface of a deformable cast polymer article having a gel coat for printing purposes, where the finished surface receives a UV and heat resistant protective coating upon dye sublimating into the finished surface.

Although several objects of some of the various exemplary embodiments have been specifically recited herein, these should not be construed as limiting the scope of the present invention in any way. Indeed, it is contemplated that each of the various exemplary embodiments comprises other objects that are not specifically recited herein. These other objects will be apparent to and appreciated by one of ordinary skill in the art upon practicing the invention as taught and described herein.

To achieve the foregoing objects, and in accordance with the invention as embodied and broadly described herein, the present invention features a method for creating a dye sublimatable cast polymer article having a protective coating. The method comprises: (a) coating a mold with a medium configured to provide, at least in part, UV and heat resistant properties; (b) disposing a polymer composition about the medium; and (c) subjecting the polymer composition and the medium to further processing to cause the medium to form to the polymer composition to produce a cast polymer article, wherein the medium provides a dye sublimatable protective coating about a surface of the cast polymer article.

In this exemplary embodiment, the cast polymer article does not comprise a gel coat. Rather, the dye is sublimated to the substrate or matrix of the cast polymer article through the protective coating. In another exemplary embodiment, the dye is sublimated directly to the substrate or matrix of the cast polymer article and a protective coating applied thereafter. In addition, the exemplary medium comprises an acrylic, or an acrylic composition.

Furthermore, the method may comprise coating the mold with a release layer, as commonly known in the art, prior to applying or coating with the medium. The medium is preferably an acrylic or acrylic composition. More specifically, the medium may be an acrylic film, having, at least in part, UV and heat resistant properties. Notably, the medium component functions to provide the sublimated dye with the UV and heat protection.

The present invention further features a dye sublimatable cast polymer article comprising: (a) a cast polymer substrate formed without a gel coat; and (b) a dye sublimatable protective coating formed about a surface of the cast polymer substrate, wherein the protective coating comprises, at least in part, heat and UV resistant properties. In this embodiment, the image is printed onto the cast polymer substrate through the protective coating.

The present invention further features a method for creating a dye sublimatable cast polymer comprising: (a) forming a cast polymer substrate; (b) dye sublimating an image into a surface of the cast polymer substrate; and (c) applying protective coating to the surface of the substrate to form a finished cast polymer article, wherein the protective coating comprises, at least in part, UV and heat resistant properties.

The present invention further features a method for printing onto a cast polymer substrate comprising (a) obtaining a deformable cast polymer article having a finished surface with a gloss coating thereon and a secondary surface opposite of the finished surface; (b) supporting the deformable cast polymer article in a printing press, wherein the printing press comprising at least one pressure platen and an actuatable and deformable pressure applicator positioned relative to one another; (c) positioning an image transfer medium about the finished surface, the image transfer medium supporting one or more inks arranged in an ink transfer image configured to transfer a pre-determined image to the finished surface; (d) heating the pressure platen to a pre-determined temperature; (e) actuating the printing press to cause the deformable pressure applicator to press the cast polymer article against the pressure platen, thus causing the cast polymer article to deform to effectuate the transfer of the image; (f) applying a coating to the finished surface to protect the transferred image and the finished surface, wherein the coating comprises, at least in part, heat and UV resistant properties.

The present invention provides significant advantages over prior art deformable synthetic cast polymer articles and methods, as will be discussed below.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1 illustrates an exploded perspective view of the various components utilized to form a dye sublimatable cast polymer article, according to one exemplary embodiment of the present invention;

FIG. 2 illustrates an elevational side view of the components utilized to form the dye sublimatable cast polymer of FIG. 1;

FIG. 3 illustrates a flow diagram depicting a method for creating a dye sublimatable cast polymer, according to one exemplary embodiment of the present invention; and

FIG. 4 illustrates a flow diagram depicting a method for printing onto a cast polymer substrate.

### DETAILED DESCRIPTION OF EXEMPLARY EMBODIMENTS

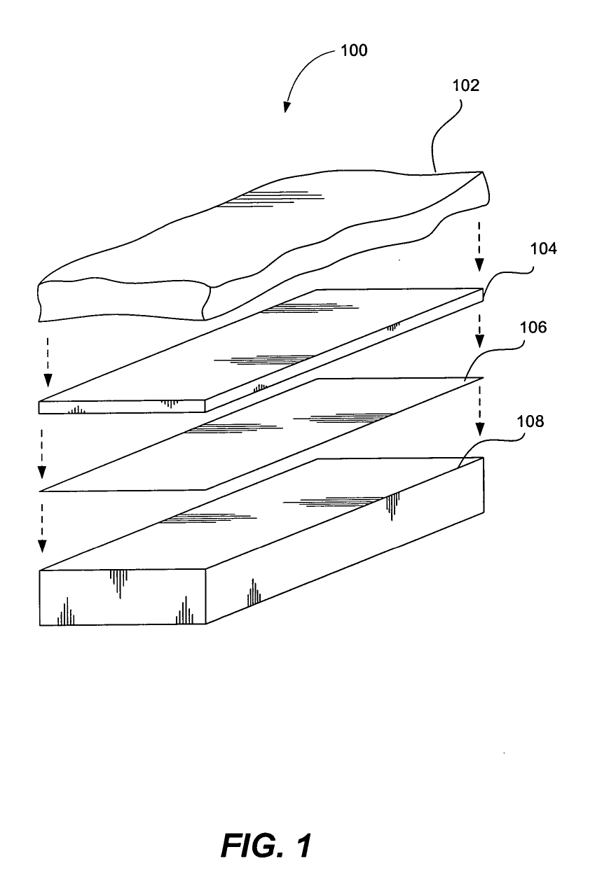

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention, as represented in FIGS. 1 through 4, is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The present invention describes various methods for forming or creating a dye sublimated cast polymer article, wherein the cast polymer article comprises a protective coating having, at least, UV and heat resistant properties. The cast polymer article may be formed with or without a gel coat. Unlike prior related cast polymer articles, particularly those having an image printed thereon, the present invention features a dye sublimated cast polymer article and method for creating or producing the same, wherein the dye may be sublimated directly to the substrate or matrix of the cast polymer article, without requiring a gel coat. In addition, the protective coating is dye sublimatable, meaning that it may be applied prior to or after the dye sublimation step. The various methods and articles produced are discussed in greater detail below.

In describing and claiming the present invention, the following terminology will be used.

Preliminarily, the singular forms “a,” “an,” and “the” include plural referents unless the context clearly dictates otherwise. Thus, for example, reference to “a polymer” includes reference to one or more of such materials.

The term “about” when referring to a numerical value or range is intended to encompass the values resulting from experimental error that can occur when taking measurements.

Preliminarily, the phrases “cast polymer,” “deformable cast polymer,” “cast polymer material”, “synthetic cast polymer”, “deformable cast polymer article,” or “cast polymer product” as used herein, as well as similar phraseology, are general phrases that shall be understood to describe and define those products and/or finishing materials that are manufactured using one or more techniques, and that are inelastically deformable. Examples of such cast polymers include, but are not limited to, cultured marble, cultured granite, and cultured onyx. In some embodiments, the cast polymer article may comprise a gel coat, while in other exemplary embodiments, the cast polymer article simply comprises a cast polymer substrate or matrix, which in such cases the dye is sublimated directly into the cast polymer substrate or matrix itself.

Although the present invention focuses on printing onto a cast polymer article, it is noted herein that this is not intended to be limiting in any way. Indeed, some solid surface articles may also lend themselves to utilizing the methodology and techniques of the present invention, and are therefore considered to be within the scope of the present invention. However, it is also specifically noted herein that for discussion purposes, the following detailed description sets forth the printing systems and methods using a cast polymer article.

The phrase “even image transfer,” as used herein, as well as similar phraseology, shall be understood to mean the even transfer of a high resolution image supported on an image transfer medium to all appropriate surface points, or substantially all of these points, of a surface of the cast polymer, wherein the surface comprises a finished surface having a gel coat, or alternatively a surface of a cast polymer substrate or matrix, and wherein the transferred image comprises high-resolution and good optical density.

The phrase “medium,” as used herein, as well as similar phraseology, shall be understood to mean any compound or composition that is capable of forming a protective coating about a cast polymer substrate or a cast polymer article for the purpose of providing suitable heat and UV resistant properties to the cast polymer substrate or article. The protective coating may be dye sublimatable, or applied subsequent to dye sublimating to a cast polymer substrate or finished cast polymer article. An acrylic or acrylic composition is one exemplary composition configured to provide a protective coating.

The term “image,” as used herein, as well as similar phraseology, shall be understood to mean the resulting image formed upon dye sublimation. The image may comprise any arrangement of colors or combination of colors to form a picture, pattern, print, solid, etc. Essentially, the image formed on the surface of the cast polymer article or cast polymer substrate refers to the resulting arrangement of dye or ink that has been sublimated into the surface.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited.

The present invention encompasses dye sublimatable cast polymers and methods for creating cast polymer articles, preferably comprising a protective coating having, at least in part, UV and heat resistant properties, wherein the protective coating may be dye sublimatable. The protective coating permits the cast polymer to be subjected to high heats. In addition, the protective coating prevents fading, scratching, or otherwise destruction of the image once formed. The primary function of the protective coating is to increase both the durability and wearablility of the cast polymer article.

The following detailed description and exemplary embodiments of the invention will be best understood by reference to the accompanying drawings, wherein the elements and features of the invention are designated by numerals throughout.

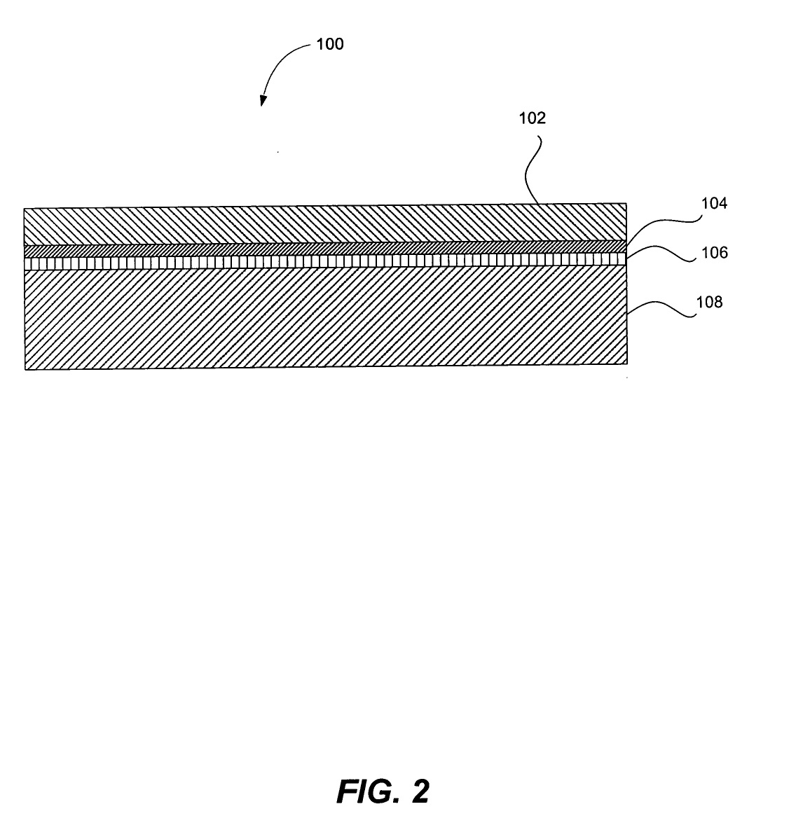

In a first exemplary embodiment, the present invention comprises forming together within a mold a dye sublimateable medium and a polymer composition. With reference to FIGS. 1 and 2, illustrated is an exemplary system for use in forming a dye sublimatable cast polymer article 100, wherein the cast polymer article comprises a polymer substrate or matrix devoid of a gel coat, such that the dye is sublimated directly to the polymer substrate or matrix rather than a gel coat, as is done on prior related cast polymer articles. The cast polymer article further comprises a protective coating that provides the cast polymer article with UV and heat resistant properties to protect the sublimated image. It is noted herein, that the deformable cast polymer article may comprise any size or shape, not just a flat or substantially flat panel or substrate.

Specifically, FIGS. 1 and 2 illustrates a mold 108 having a working surface to receive a release layer 106. The mold 108 can be pre-fabricated with a substantially flat or contoured surface in the shape of the desired cast polymer article. In one embodiment, the mold provides a substantially flat working surface. In yet an alternative embodiment the mold provides a contoured working surface having corners, curves, indentations or surface protrusions. The pre-formed working surface defines the desired shape of the cured cast polymer article. Furthermore, the mold may be a porous or non-porous material comprised from various materials such as a metal, ceramic, glass, or a composite material. In an exemplary embodiment of the present invention the mold can be substantially flat, having side protrusions to encase the polymer materials and being made from aluminum or aluminum alloys.

The release layer 106 can be configured to prevent the polymer composition 102 from bonding or adhering to the working surface of the mold 108. The release layer 106 can be applied to the mold 108 by spraying, pouring, brushing, wiping, rolling, or by any other suitable hand applying means. Generally, the release layer 106 can be applied by a wiping method. The composition of release layer can vary depending on the desired application, as well known in the art. In one aspect of the present invention the release layer composition is a polyurethane polymer. Generally, a thin coating of release layer 106 will be sufficient to prevent the bonding or adhering of the polymer composition 102 to the mold 108.

Subsequent to coating the mold 108 with the release layer 106, a medium 104 is applied to the release layer 106. The medium 104 may be an acrylic or acrylic composition or any other composition capable of providing a protective element to the formed cast polymer article. In an exemplary, yet preferred, embodiment, the medium 104 is configured such that the resulting protective coating provides UV and heat resistant properties to the formed cast polymer. The medium 104 and the resulting protective coating may also be dye sublimatable, or in other words, may allow a dye to sublimate through the protective coating and into the cast polymer substrate or matrix. Particularly, the medium and resulting protective coating can comprise any suitable composition which may be subject to temperatures in the range of about 325° to 425° F., and UV radiation. In one exemplary embodiment, the medium 104 may be comprised of an acrylic composition capable of being applied to the mold to form a film thereabout. In another exemplary embodiment, the medium 104 may comprise a mixture of acrylic and epoxy compounds. In essence, the medium 104 is intended to comprise any compound or composition configured to provide UV, heat resistant, and other properties to the formed cast polymer article. The medium 104 may also be configured to be dye sublimatable, such as in the case where the medium forming the protective coating is applied after the cast polymer article is formed, and prior to dye sublimation. In addition, various additives may be incorporated into the composition of the medium, thus giving the resulting protective coating additional protective properties. For example, organic compositions may be added to increase the UV or heat resistant properties of the composition or the organic compositions may alter the acrylic formulation to enhance dye sublimating properties.

During processing, the medium 104 is configured to form or bond to the polymer composition 102 applied about the medium 104, which bond functions to form the protective coating discussed herein. As such, the present invention contemplates the necessary processing steps known in the art for achieving a bond. However, a bonded relationship between the medium 104 and the polymer composition 102 is not to be limiting in any way. Indeed, other types of protective coatings may be utilized that do not form a bond with the polymer composition 102.

In a specific exemplary embodiment, the medium 104 comprises a liquid acrylic composition which may be applied to the release layer 106 disposed about the surface of the mold 108 by spraying, pouring, brushing, rolling or any other suitable applying means. Once applied, the acrylic medium is further processed to enable it to form or otherwise bond to the polymer composition 102. Further processing may comprise, as an example, exposing the acrylic medium 104 to UV radiation from a UV light source, thereby physically changing or solidifying the liquid to a solid form and effectuating the bonding of the medium 104 to the polymer composition 102. Other processing methods may be employed as known in the art.

The resulting form is an acrylic protective coating disposed about a surface of the formed cast polymer article, wherein the protective coating comprises protective properties, such as UV and heat resistant properties, and in some cases, is dye sublimatable. Particularly, the acrylic medium can inherently possess substantial dye sublimatable properties favorable for ink image transfer.

As indicated, a polymer composition 102 is thereafter applied in preparation of forming a dye sublimatable cast polymer article 100. Particularly, the polymer composition 102 is comprised of a resin and rock, marble, or stone particles, such as stone dust, flour, or sand. Depending on the desired finish product, the resin may be mixed with granite particles to give the appearance of a granite slab. The resin incorporated into the polymer composition 102 is typically an acrylic, epoxy, polyester resin or mixtures thereof. In addition, polymer composition 102 may be at least a two component composition. For example, the polymer composition 102 may include marble particles, an acrylic resin, and a catalyst to increase the curing time. It is noted herein that the polymer composition is configured to form a cast polymer article devoid of a gel coat. Unlike many prior related cast polymer articles that utilize a gel coat, the present invention contemplates dye sublimating directly into a polymer substrate or matrix not having a gel coat. In other words, the polymer composition used to form the cast polymer article is not further processed to comprise a gel coat as are many other cast polymer articles commonly known in the art, such as common cultured marble. This is advantageous in that gel coats tend to yellow under a lack of or insufficient oxygenated environment. A gel coat also has a tendency to yellow under extreme heat and pressure, such that used in a dye sublimation process. The yellowing can cause inconsistency in colors from article to article or piece to piece, thus making it difficult to match pieces together.

The polymer composition 102 may be disposed about the medium layer 106 in accordance with any suitable applying means as commonly known in the art. In one exemplary embodiment, the polymer composition 102 is prepared by batch mixing a polyester component with marble particulates in a separate container. Once thoroughly mixed, the polymer composition 102 forms a polymer matrix having a solid yet flexible consistency that can be rolled disposed about the medium layer 104. Subsequently, the various components used to form the cast polymer article can be vibrated to release any air bubbles or pockets prior to curing. Typically, the cast polymer materials can cure within an hour of mixing. The curing process can be expedited as noted above with the addition of a catalyst or external stimuli (e.g. heat or pressure). During the curing process, the medium 104 and polymer composition 102 react or bond together to form the desired cast polymer article 100. In this manner, the protective coating is provided as part of the cast polymer article prior to dye sublimation.

The cured cast polymer article 100 can have conducive dye sublimatable properties, wherein a dye may be sublimated directly into substrate or matrix of the cast polymer article through the protective coating formed about its surface. In accordance with the present invention, the cast polymer article, devoid of a gel coat, is still dye sublimatable. The dye may be caused to penetrate and sublimate into the protective coating. In addition, the dye may be caused to penetrate and sublimate into both the protective coating and the cast polymer matrix or substrate beneath the protective coating.

In another exemplary embodiment, a cast polymer article is first formed, then dye is sublimated directly to the polymer article matrix, then coated with protective coating. Specifically, a dye sublimatable cast polymer is formed using a similar process above so that the cast polymer article is devoid of a gel coat, only the protective coating is applied subsequent to the sublimation of dye to form the image on the cast polymer article. In this embodiment, the polymer can be prepared by providing a mold with the desired shape of the polymer. However, rather than disposing a medium about the mold that will function as a protective coating, the polymer composition is disposed directly about the surface of the mold. As before, a release layer may be disposed about the mold to prevent the polymer from bonding or affixing to the surface of the mold. In one exemplary aspect, a batch of acrylic resin and marble dust can mixed together to form the polymer composition. Once mixed to the desired consistency, the polymer composition can be disposed about the surface of the mold, or a portion thereof. The polymer composition may be further processed to form a cast polymer article devoid of a gel coat. In addition, the polymer composition may be subjected to other processing steps, such as by subjecting the polymer composition to heat, to increase the curing rate and to form the cast polymer article.

Once formed, the cast polymer article can be subjected to an image transfer or printing process, such as a dye sublimation process configured to transfer a dye image directly into a matrix surface of the cast polymer article, again, which matrix surface is devoid of a gel coat. Following dye sublimation to achieve an image on the surface of the cast polymer article, a protective coating having UV, heat, and other protective properties may be applied to the sublimated surface of the cast polymer article. The protective coating functions as described herein to protect the printed surface of the cast polymer article and to increase the durability and wearability properties of the cast polymer article and the image printed thereon. Moreover, it is noted that the applied protective coating may also be dye sublimatable in the event subsequent dye sublimation is desired.

The particular techniques and materials used to dye sublimate the cast polymer article, such as the particular printing techniques and methods, either through the protective coating or into the cast polymer substrate or matrix itself, are not described herein. Indeed, dye sublimation printing techniques and materials are commonly known in the art. In one particular example, the cast polymer article may be subjected to the printing techniques or methods described and taught in U.S. Provisional Patent Application No. 60/649,647, which is incorporated herein by reference in its entirety. Moreover, the particular dye utilized in the dye sublimation process may be any dye suitable for a dye sublimation process. Dyes providing good lightfastness and other properties are preferred, but not required.

In another exemplary embodiment, a cast polymer article is first formed, then a dye sublimateable protective coating is applied to the cast polymer article, then the protected cast polymer article is sublimated with one or more dyes. Specifically, a dye sublimateable cast polymer is formed using a similar process above so that the cast polymer article is devoid of a gel coat, only the protective coating is dye sublimateable and is applied after the formation of the cast polymer article and prior to the sublimation of dye to form the image on the cast polymer article. In this particular embodiment, the formed and cured cast polymer article may be subjected to a printing process after the protective coating has been applied thereto due to the fact that the protective coating is a dye sublimateable protective coating, as well as one that provided heat and UV resistant properties. In other words, the present invention contemplates a cast polymer article being formed that is devoid of a gel coat, wherein a protective coating is applied thereafter directly to the substrate or matrix of the cast polymer article, and wherein the protective coating is a dye sublimateable coating. This embodiment is unlike those described above where the protective coating and polymer composition are formed together in a mold, or where the protective coating is applied after printing onto a formed cast polymer article. Rather, this embodiment contemplates a protective coating that is applied after the formation and curing of the cast polymer article and before printing thereon.

The type of coating that may be used in this embodiment is preferably acrylic based, but may be any other type of protective coating known by those skilled in the art having certain properties, namely that is dye sublimateable, and that provides sufficient heat and UV resistant properties.

In still another exemplary embodiment, an additional top coat may be applied to any of the above manufactured articles. Indeed, any of the formed cast polymer articles discussed herein may comprise an additional top coating disposed about the protective coating and following dye sublimation, wherein the additional top coat is configured to provide further protection to the cast polymer article. In one exemplary embodiment, the additional top coat may provide additional UV and heat resistant properties.

The top coat may comprise any suitable material or composition. In one exemplary embodiment, the top coat may comprise an acrylic base polymer mixture. In another embodiment, the top coat may comprise an acrylic compound. The top coat may be applied to the cast polymer article by any suitable means known by those skilled in the art including, but not limited to, hand spraying, robotic spraying, brushing, rolling, and wiping.

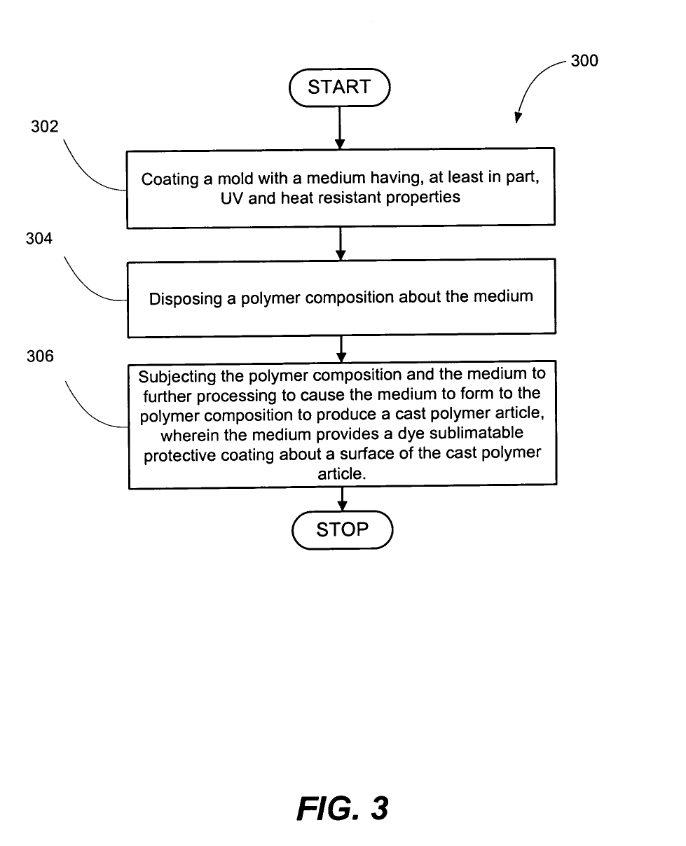

With reference to FIG. 3, illustrated is a flow diagram depicting a method for creating a dye sublimatable cast polymer, according to one exemplary embodiment of the present invention. Specifically, FIG. 3 illustrates the method as comprising step 302, coating a mold with a medium having, at least in part, UV and heat resistant properties; step 304, disposing a polymer composition about the medium; and step 306, processing the polymer composition and the medium to cause the medium to form to the polymer composition to produce a cast polymer article devoid of a gel coat, wherein the medium provides a protective coating about a surface of the cast polymer article. The protective coating may be a dye sublimatable protective coating. As such, the method further comprises the step of dye sublimating into the cast polymer article through the protective coating, wherein the dye is caused to penetrate at least the protective coating, and possibly the cast polymer article substrate or matrix.

In an alternative process, the cast polymer article may be formed using the same method just described, only without first applying a medium configured to bond to the polymer composition to form a protective coating for the formed cast polymer article. In this particular method, the cast polymer article is formed without the protective coating, although still being dye sublimatable. Once the cast polymer article is formed, it is dye sublimated to provide an image on one of its surfaces. Being devoid of a gel coat, the cast polymer article is configured to receive the dye from the dye sublimation process directly to its substrate or matrix. Once sublimated, a protective coating may be applied to the cast polymer article using any known technique or process and any known material or composition.

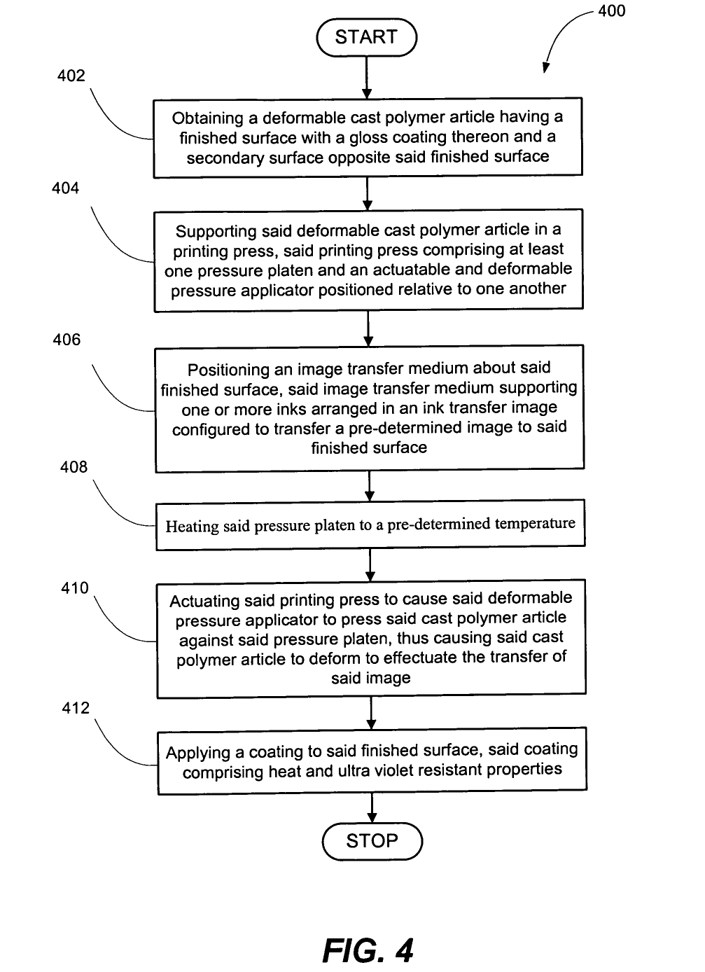

FIG. 4 illustrates a flow diagram of a method 400 for printing onto a cast polymer article according to another exemplary embodiment, wherein the cast polymer article comprises a gel coat as commonly known in the art. In this embodiment, the method comprises, as an initial step, step 402 obtaining a deformable cast polymer article having a finished surface comprised of a gel coat, and a secondary surface opposite the finished surface; step 404, supporting the deformable cast polymer article in a printing press, the printing press comprising at least one pressure platen and an actuatable and deformable pressure applicator positioned relative to one another; step 406, positioning an image transfer medium about the finished surface, the image transfer medium supporting one or more inks arranged in an ink transfer image configured to transfer a predetermined image to the finished surface; step 408, heating the pressure platen to a pre-determined temperature; step 410, actuating the printing press to cause the deformable pressure applicator to press the cast polymer article against the pressure platen, thus causing the cast polymer article to deform to effectuate the transfer of the image; and step 412, applying a coating to the finished surface, wherein the coating comprises, at least, heat and UV resistant properties.

The coating in step 412 can comprise any type of a coating, such as an acrylic coating as discussed above, or a silicon or other type of coating as commonly known in the art. In addition, the cast polymer article may be formed and printed thereon using other techniques as commonly known in the art.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those in the art based on the foregoing detailed description. The limitations in the claims are to be interpreted broadly based the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are expressly recited. Accordingly, the scope of the invention should be determined solely by the appended claims and their legal equivalents, rather than by the descriptions and examples given above.

What is claimed and desired to be secured by Letters Patent is:

1. A method for creating a dye sublimatable cast polymer article having a protective coating, the method comprising:
coating a mold with a medium having, at least in part, UV and heat resistant properties;
disposing a polymer composition within the mold and about the medium;
processing the polymer composition and the medium to cause the medium to form to the polymer composition to produce a cast polymer article devoid of a gel coat, wherein the medium provides a dye sublimatable protective coating about a surface of the cast polymer article.

2. The method of claim 1, wherein the medium comprises an acrylic composition.

3. The method of claim 1, further comprising sublimating a dye into the surface through the protective coating.

4. The method of claim 1, further comprising applying an additional top coating to the protective coating formed on the surface of the cast polymer article.

5. The method of claim 1, further comprising applying a release layer to the mold prior to the coating of the mold with a medium.

6. A dye sublimatable cast polymer article comprising:
a polymer substrate devoid of a gel coat; and
a dye sublimatable protective coating formed about a surface of the polymer substrate, wherein the protective coating comprises heat and UV resistant properties.

7. The article of claim 6, wherein the protective coating comprises an acrylic composition.

8. The article of claim 7, further comprising an additional protective coating applied to the surface.

9. A method for creating a dye sublimatable cast polymer article, the method comprising:
disposing a polymer composition within a mold;
processing the polymer composition to form a cast polymer article devoid of a gel coat, wherein the cast polymer article provides at least one surface configured to receive a sublimated dye.

10. The method of claim 9, further comprising:
sublimating the surface with a dye to provide an image thereon; and
applying a protective coating to the dye sublimated surface, wherein the protective coating comprises, at least in part, UV and heat resistant properties.

11. A method for printing onto a cast polymer substrate comprising:
obtaining a deformable cast polymer article having a finished surface with a gloss coating thereon and a secondary surface opposite the finished surface;
supporting the deformable cast polymer article in a printing press, the printing press comprising at least one pressure platen and an actuatable and deformable pressure applicator positioned relative to one another;
positioning an image transfer medium about the finished surface, the image transfer medium supporting one or more inks arranged in an ink transfer image configured to transfer a pre-determined image to the finished surface;
heating the pressure platen to a pre-determined temperature;
actuating the printing press to cause the deformable pressure applicator to press the cast polymer article against the pressure platen, thus causing the cast polymer article to deform to effectuate the transfer of the image; and
applying a coating to the finished surface, the coating comprising heat and ultra violet resistant properties.
